(19) United States
(12) Patent Application Publication
(10) Pub. No.: US 2024/0351460 A1
(43) Pub. Date: Oct. 24, 2024

(54) Elektrische Anschlusseinheit für ein Ladekabel, Ladekabel und Steckverbinderadapter

(71) Applicant: Robert Bosch GmbH, Stuttgart (DE)

(72) Inventors: Alexander Goerzen, Rangendingen (DE); Andriy Melnykov, Ellhofen (DE); Matthias Musialek, Dossenheim (DE); Petr Tesar, Olesnik (CZ)

(21) Appl. No.: 18/638,910

(22) Filed: Apr. 18, 2024

(30) Foreign Application Priority Data
Apr. 20, 2023 (DE) 10 2023 203 632.0

(51) Int. Cl. B60L 53/18; B60L 53/16

(52) U.S. Cl. CPC B60L 53/18; B60L 53/16

(57) ABSTRACT

The invention relates to an electrical connection unit, the electrical connection unit comprising:
a connector (1), the connector (1) comprising:
a first end (2) with a first plug face (3), set up for connection to a first socket (4);
a second end (6);
a connector adapter (9), comprising:
a coupling (10) for coupling to the first plug face (3);
a second plug face (11) for connecting to a second socket (12);

wherein the connector adapter (9) is coupled to the first plug face (3) by means of the coupling (10),

wherein the first plug face (3) has a protective conductor contact (14) and at least two, in particular current-carrying, contacts (15, 16), wherein the second plug face (11) has a further protective conductor contact (17) or a neutral conductor and at least two further, in particular current-carrying, contacts (18, 19), and
wherein the second plug face (11) is offset perpendicular to a mounting direction (M) of the connector adapter (9) relative to the coupling (10) of the connector (1), and/or
wherein the at least two further contacts (18, 19) are arranged closer to the second end (6) of the connector (1) relative to the at least two contacts (15, 16) and the protective conductor contact (14) is arranged between the at least two contacts (15, 16) and the at least two further contacts (18, 19).

### BACKGROUND

The invention relates to an electrical connection unit for a charging cable, a charging cable and a connector adapter.

There is currently only one charging cable technology on the market that enables the charging of electric vehicles such as battery electric vehicles, plug-in hybrids or the like using a charging cable via a household socket or a socket without a control cable(s). Hereby the electronics that control and monitor the entire charging process are located between a vehicle-side plug and a household plug or household-side connector in the middle of a supply line or connecting line of the charging cable in a so-called “In Cable Control Box” (ICCB).

A charging cable is known from U.S. Pat. No. 10,749,370 B2, in which the entire electronics are integrated in the connector on the household side of the charging cable. However, hereby the construction is mechanically unstable, as the connection between the cable itself and the housing is comparatively far away from the wall. This means that a higher torque acts on the housing or the plugged-in plug or connector.

DE 10 2021 203 363 A1 counteracts this disadvantage by dividing the functions of the electronics controlling the charging process between the two connectors (vehicle-side connector and household-side connector), so that the household-side connector is lighter and the torque acting on the connector is reduced. The application DE 10 2021 203 363 A1 and its technical teaching are referred to in their entirety for the present application.

It is also known that different types of sockets with different socket shapes can be provided in different countries or even in the same country. It can be necessary to provide a connector with a corresponding plug face for each socket shape. This is particularly pronounced in the USA, for example. In the USA, there are different types of sockets that can be found in a household. Hereby, for example, a distinction is first made between the input voltage of 120 V or 240 V. In terms of charging, this is referred to as level 1 charging (in the range of 100 V, e.g. with approx. 120 V) or level 2 charging (in the range of 200 V, e.g. with approx. 240 V), depending on the input voltage. Furthermore, different socket shapes and corresponding plug faces are provided for different maximum currents, which are known as different NEMA standards and, for example, can be accessed at https.//de.wikipedia.org/wiki/NEMA-Stecker.

A charging cable with an in-cable control box is known from U.S. Pat. No. 11,305,657 B2. The charging cable has a connector with a first plug face as NEMA 14-50, wherein the connector has no or only a few electrical or electronic components, in particular no voltage converter or no voltage supply and/or no switching unit or no relay(s). To enable the connector to also be connected to a socket with a lower voltage in the 100V range (e.g. 120V) and with a lower maximum current, e.g. to a NEMA 5-15 socket, a connector adapter with a coupling and a second plug face is provided, which is mounted on the first plug face along a mounting direction by means of the coupling. It is intended that the second plug face is essentially aligned with the first plug face.

### SUMMARY

The invention is based on the realization that the provision of a plurality of household connectors with different plug faces leads to a high space requirement in a user's vehicle, that the user incurs high costs for the purchase of the different connector types for the different socket types and that, in addition, the quantities to be produced of the different connector variants or connector types are relatively small, which unnecessarily increases the costs and the effort on the part of the manufacturers of such connectors. Furthermore, the invention is based on the realization that the integration of electronic components in the household-side connector leads to an increased weight and, due to the necessary accommodation of the electrical and electronic components of the household-side connector, also results in a greater distance of the center of gravity of the (household-side) connector from the socket or a wall or support structure in which or on which or to which the socket is mounted. This increases the torque acting on the connector or on its electrical contacts plugged into the socket, which can lead to unwanted loosening or disengagement of the connector from the socket, especially since the household connector is not usually mechanically locked compared, for example, with a TYPE2 plug that can be plugged into a public charging station, for example.

There can therefore be a need to provide an electrical connection device for a charging cable, in particular for a charging cable without ICCB, which enables mechanical and electrical connection to sockets with different socket shapes in a cost-effective and simple manner and which, when plugged in, is plugged into the socket used as stably and permanently as possible (in particular also without a locking mechanism) and, in particular, does not easily come loose or loosen from the socket, e.g. solely due to the weight of the connector and the connecting line of the charging cable connected to it or due to movements of the charging cable or the connecting line.

This need can be met by the object of the present invention according to the independent claims. Advantageous embodiments of the present invention are described in the dependent claims.

According to a first aspect of the invention, an electrical connection unit for a charging cable is proposed.

The electrical connection unit has a connector. The connector has a first end or a first section with a first plug face, wherein the first plug face is set up for connection to a first socket with a first socket shape (corresponding to the first plug face). The connector also has a second end or a second section for detachable or non-detachable coupling with a connecting line of the charging cable. The electrical connection unit also has a connector adapter. The connector adapter has a coupling for coupling to the first plug face and a second plug face for connecting to a second socket with a second socket shape that is different from the first socket shape. The connector adapter is coupled or can be coupled to the first plug face of the connector by means of the coupling, wherein the first plug face has a protective conductor contact and at least two contacts, in particular current-carrying contacts (these are in particular different from the protective conductor contact). The second plug face has a further protective conductor contact or a neutral conductor contact and at least two further contacts, in particular current-carrying contacts (these are in particular different from the further protective conductor contact or the neutral conductor).

It is provided that the second plug face is offset essentially perpendicular to a mounting direction of the connector adapter relative to the coupling, in particular in the direction of the second end of the connector.

The coupling of the connector adapter and/or the first plug face and the second plug face can overlap, for example, over a maximum of 25% of their respective surfaces. In other words: of the surface of the coupling (and/or the first plug face), a maximum of 25% overlaps with the surface of the second plug face. At the same time, a maximum of 25% of the surface of the second plug face overlaps with the surface of the coupling (and/or the first plug face).

The advantage of this is that one and the same connector can be connected to different types of sockets or to sockets with different socket shapes. This saves costs and also space in the vehicle, as otherwise a separate connector or even a separate charging cable would have to be provided for each type of socket. Furthermore, the axial displacement of the second plug face of the connector adapter relative to the coupling and/or to the first plug face of the connector advantageously causes the torque acting on the electrical connection unit to be reduced compared to a state in which the second plug face is essentially aligned with the first plug face. This also reduces the torque acting on the contacts (e.g. (current-carrying) contacts, protective conductor contact or neutral conductor contact, possibly dummy contact(s)) of the connector or the electrical connection unit (e.g. a lever arm is shortened) and the risk of the connector coming loose from the socket or the plug becoming loose is reduced. Particularly for connectors that have electrical and/or electronic components, such as a switching unit or at least one relay, sensors, electrical circuits, voltage converters and/or active and/or passive electrical components and therefore have a higher weight, such a shift of the second plug face and therefore the pivot point is particularly advantageous compared to a connector adapter whose second plug face is essentially aligned with the first plug face.

A surface of the second plug face can be delimited by the shortest line that runs around the other contacts and the protective conductor contact or the neutral conductor contact or by the shortest line that runs around the structures projecting outwards from a surface of the second plug face (in addition to the aforementioned contacts and the protective conductor contact or neutral conductor contact, this can also include, for example, contacts that are intended for a socket type but have no electrical function in a specific configuration of the electrical connection unit; they can also be referred to as dummy contacts, for example). This means that all contacts are within the surface of the second plug face.

One surface of the coupling can be defined by the shortest line that runs around the coupling elements with which the contacts and the protective conductor contact of the first plug face are contacted. This means that all coupling elements are located within the surface of the coupling. The coupling elements or the coupling element can preferably be designed as female contact(s) or as male contact(s) if the corresponding contacts or the corresponding contact of the first plug face are designed as male contact(s) or as female contact(s).

Alternatively or additionally (to the displacement of the second plug face), it is provided that the at least two further, in particular current-carrying, contacts are arranged closer to the second end of the connector relative to the at least two, in particular current-carrying, contacts and the protective conductor contact is arranged between the at least two (in particular current-carrying) contacts and the at least two further (in particular current-carrying) contacts, in particular viewed along a line extending from the first end to the second end.

The advantage of this is that one and the same connector can be connected to different types of sockets or to sockets with different socket shapes. This saves costs and also space in the vehicle, as otherwise a separate connector or even a separate charging cable would have to be provided for each type of socket. Furthermore, the axial displacement of the second plug face of the connector adapter relative to the coupling and/or to the first plug face of the connector has the advantage that the torque acting on the electrical connection unit is reduced compared to a state in which the second plug face is essentially aligned with the first plug face. This also reduces the torque acting on the contacts (e.g. (current-carrying) contacts, protective conductor contact or neutral conductor contact, possibly dummy contact(s)) of the connector or the electrical connection unit (e.g. the lever arm is shortened) and the risk of the connector coming loose from the socket or the plug becoming loose is reduced. Particularly for connectors that have electrical and/or electronic components, such as a switching unit or at least one relay, sensors, electrical circuits, voltage converters and/or active and/or passive electrical components and therefore have a higher weight, such a shift of the second plug face and therefore the pivot point is particularly advantageous compared to a connector adapter whose second plug face is essentially aligned with the first plug face.

The connector adapter can be plugged directly onto the first plug face, for example.

It is understood that the connector adapter can preferably be designed as a rigid part, for example. The connector adapter can, for example, preferably be designed as a one-piece element. The connector adapter can, for example, preferably be designed as a compact element or part. The connector adapter can, for example, have a thickness or depth of no more than 7 cm, preferably no more than 5 cm (not counting the second contacts). A (flexible) cable with two connections that have different plug faces or socket shapes, wherein the two connections can be moved in height relative to each other by means of the (flexible) cable, is preferably not to be regarded as a connector adapter.

For example, it can be preferable for the connector adapter to have exactly one single coupling.

For example, it can be preferable for the connector adapter to have exactly one single plug face.

An axial direction can, for example, extend along a longitudinal direction of the connector housing. For example, it can run parallel to a line between the first end and the second end. A radial direction can run perpendicular to the axial direction. A direction of rotation can rotate around the axial direction.

For example, the direction in which or along or parallel to which the connector adapter is mounted, e.g. plugged on, to the connector can be regarded as the mounting direction. The mounting direction can, for example, be essentially parallel to the radial direction. In principle, it can also run in any other direction, e.g. parallel to the axial direction.

The first or second, in particular current-carrying, contacts of the first plug face can, for example, be regarded as line contacts (as opposed to signal contacts with a lower current-carrying capacity). They have, for example, at least one contact to which a current phase is applied (phase contact) and, for example, at least one contact that serves as a neutral conductor. It is also possible that more than one phase contact is provided. For example, a single phase contact or two or three phase contacts and a neutral conductor can be provided.

It can be provided that the second plug face has a dedicated additional protective conductor contact. In other cases (e.g. in the case of a NEMA 10-30 type), provision can be made for a neutral conductor and two phase-carrying contacts, for example, in the associated socket. In this case, for example, the protective conductor contact of the first plug face can be connected to the neutral conductor contact of the second plug face. The two additional contacts can therefore be two contacts that are connected to phase lines of the second socket in the case connected to the second socket. It can be provided that one of these two further contacts is electrically connected to the neutral conductor via a high resistance (e.g. more than 10 kOhm or more than 100 kOhm or more than 1 MOhm).

The second plug face of the connector adapter can have more than three contacts, for example.

For example, at least one of the contacts can be designed as a dummy contact that does not fulfill an electrical function but is only intended for mechanical support. In contrast to the other contacts and the protective conductor contact or the neutral conductor, such a dummy contact does not have to be made of an electrically conductive material, but it can also be made of an electrically conductive material. One or more such dummy contacts can be used to improve the mechanical plug connection and reduce the risk of undesired disconnection or loosening of the plug connection of the electrical connection unit from the second socket. Such a dummy contact can, for example, be electrically connected to one of the other, in particular current-carrying contacts and/or to the other protective conductor contact or the neutral conductor contact of the second plug face, in particular with the interposition of a high electrical dummy contact resistance, e.g. of more than 10 kOhm or more than 100 kOhm or more than 1 MOhm.

The connector can be a connector with a similar or identical design to the infrastructure-side connector of DE 10 2021 203 363 A1, which is referred to there as the first connection. However, the connector can have other electrical and/or electronic components than the electrical and/or electronic components mentioned in DE 10 2021 203 363 A1.

The connector and/or the charging cable can be set up to enable bidirectional power transport. If, for example, electricity is taken from a vehicle's energy storage system and fed to a consumer or another vehicle, the energy storage system is ultimately discharged. The charging cable is therefore actually a supply cable. For better readability, the term charging cable is nevertheless used in the application.

For example, it can be provided that electrical and/or electronic components are provided in the connector that safely enable operation with a maximum permitted voltage (e.g. 230V or 250V) and/or a maximum permitted current (e.g. 30A or 50A). It can be provided that, depending on the type of the second socket of the connector, these maximum possible voltage values or current values are exhausted, but it can also be that the second socket belongs to a type to which a lower maximum voltage (e.g. 110V or 120V or 130V) and/or a lower maximum current (e.g. at most 20 A or at most 15 A) is assigned according to the standard. For example, it can be provided that the electrical and/or electronic components of the connector are designed or set up to enable safe and reliable operation of the connector (and thus also of the electrical connection unit and/or the charging cable) even for such lower maximum voltages and/or maximum currents. In other words, the components of the connector can, for example, be designed or constructed for a plurality of maximum possible voltages and/or currents. This makes it advantageously possible for a single connector to be operated with or on different connector standards with regard to the associated voltages and currents. An ICCB (“In Cable Control Box”) is not required for this. This means that a charging cable fitted with the connector can be particularly compact and lightweight.

For example, it can be provided that the connector adapter is connected to the connector by a fastening means (this does not refer to the (current-carrying) contacts or the protective conductor contact) or can be fastened to it. The fastening means can, for example, be designed as a union nut, a clip connection, a bayonet catch or the like. The fastening means advantageously creates a functional separation between the electrical functions of the contacts and the mechanical connection between the connector adapter and the connector. This has the advantage of ensuring a permanent electrical connection. The fastening means can preferably be provided on the connector adapter. However, it can be provided alternatively or additionally on the connector.

The term “comprise” is used synonymously with the term “have” in this application, unless otherwise stated.

In a further development, it is provided that the connector has a connector housing which extends along a longitudinal axis, wherein the first plug face projects from the connector housing in a radial direction perpendicular to the longitudinal axis, wherein the connecting line is coupled or can be coupled to the connector housing along the longitudinal axis.

This has the advantage that the center of gravity of the connector is close to the socket or to a structure containing the socket, e.g. a wall, whereby the torque acting on the contact point (plug face to socket) is particularly low and the risk of the connector coming loose from the socket is reduced.

The connector housing can, for example, be flat along the radial direction. This advantageously shifts the center of gravity close to the structure with the socket. The flatness can result, for example, from the fact that a length of the connector housing along the longitudinal axis is at least twice as great, preferably at least three times as great and particularly preferably at least four times as great as a depth or width of the connector housing, wherein the depth or width of the connector housing can extend perpendicular to the longitudinal axis, preferably essentially parallel to the plugging direction of the connector into the socket.

It can be advantageously provided, for example, that a side or wall of the connector housing facing the socket is flat or flat, wherein the first plug face is formed or arranged on the connector housing in such a way that, when plugged into the first socket, this side or wall rests against the structure or wall comprising the socket or is only a short distance (e.g. less than 1 cm or less than 5 mm) from the structure or wall when the connector is coupled to the socket or is plugged into the (first) socket. This advantageously reduces or avoids rotation or torque (or at least the distance to the stop against the wall) of the connector towards the structure or wall containing the socket, as the connector housing rests against the structure or wall (or runs very close to it). This reduces the risk of the plug connection loosening or coming loose.

It can be advantageous, for example, for the connecting line of the charging cable or supply cable to protrude from the connector at the second end of the connector along the longitudinal axis of the connector.

The first end or the first section and the second end or the second section of the connector can also be a first end or a first section and a second end or a second section of the connector housing.

In a further development, it is provided that the connector housing has a recessed section at the first end, wherein the recessed section is designed to accommodate the connector adapter, wherein the first plug face is formed on a holder in the recessed section.

This advantageously ensures that a displaced center of gravity of the electrical connection unit is as close as possible to the structure or wall with the second socket, thereby minimizing the torque acting on the contact point. Further advantageously, this means that the connector or the connector housing does not protrude as far from the structure or wall comprising the second socket, in particular compared to a connector in which no recessed section is provided. In principle, the connector adapter is recessed in the recessed section and the second plug face therefore does not protrude as far from the surface of the connector housing. This reduces the possible tilting path or angle of rotation of the connector or the electrical connection unit towards the wall. The displaced center of gravity is the center of gravity of the electrical connection unit. It is displaced relative to the center of gravity of the connector without the connector adapter fitted.

For example, it can be provided that a holder surface of the holder facing the socket is essentially aligned with a wall of the connector housing facing the socket and adjoining the recessed section.

This advantageously ensures that the connector lies as flat as possible against the structure or wall containing the (first) socket without the connector adapter being fitted or mounted. This advantageously prevents or at least reduces wobbling or rotation of the connector towards the structure or wall. This reduces the risk of the plug connection loosening or coming loose. At the same time, the connector adapter can be easily recessed.

In a further development, it is provided that the holder is spaced from the wall adjacent to the recessed section.

For example, viewed in the longitudinal direction, a spacing, e.g. in the form of a recess, e.g. a kind of depression or a trench, can be formed between the holder and the wall adjacent to the recessed section towards the second end. The holder can-merely as an example—project from the connector housing in the form of an island in the recessed section.

This has the advantage that the connector adapter can be mounted or fastened to the connector particularly securely. Another advantage of this is that a particularly tight connection can be created between the connector housing and the connector adapter. This prevents moisture, dirt, grime or the like from penetrating between the connector adapter and the connector housing in a particularly reliable manner. This increases safety, e.g. when using the electrical connection unit outdoors. The connector adapter can, for example, surround the holder with a first side that has the coupling.

Another advantage is that a sealing element can be provided between the connector adapter and the connector, for example, which further improves the seal against fluid media, dirt and grime.

In a further development, it is provided that the protective conductor contact of the first plug face is aligned with the other protective conductor contact of the second plug face.

This makes it particularly easy to design and manufacture the connector adapter. As a result, only a few and short rewirings are required in the connector adapter, particularly with regard to the protective conductor contacts. This also has the advantage of improving the safety of the electrical connection unit, as the functionality of the protective conductor contacts is ensured particularly safely and permanently thanks to this geometric configuration and the short or even unnecessary rewiring. This can also advantageously result in a well-defined displacement of the second plug face relative to the first plug face.

In a further development, it is provided that the further protective conductor contact or the neutral conductor is hollow at its end facing the protective conductor contact and the protective conductor contact is plugged into the further protective conductor contact or the neutral conductor.

This enables a particularly compact design with a very small depth or width of the connector adapter. The overall depth of the connector adapter is advantageously reduced. This also reduces or minimizes the overall depth or width of the electrical connection unit.

The further protective conductor contact can, for example, be hollow along at least 25% of the length of the further protective conductor contact or along at least 50% of the length of the further protective conductor contact or along at least 75% of the length of the further protective conductor contact. This allows the protective conductor contact to be inserted particularly far into the other protective conductor contact or the neutral conductor of the connector adapter. This has the advantage that the depth or thickness of the connector adapter can be reduced particularly well. Another advantage is that this enables a particularly large contact surface and thus a low contact resistance. Furthermore, the additional protective conductor contact is particularly easy to manufacture if it is hollow along at least 25% of its length.

It is possible, for example, that the protective conductor contact only partially fills the hollow interior of the other protective conductor contact or neutral conductor, particularly when viewed along its length. In other words: an empty cavity can remain in front of the tip of the inserted protective conductor contact. This can, for example, be at least 10% or at least 20% or at least 30% of the length of the other protective conductor contact.

It is possible, for example, for the additional protective conductor contact or the neutral conductor to be formed in one piece.

It is possible, for example, for the additional protective conductor contact or the neutral conductor to be cup-shaped. In other words, the walls surrounding the hollow interior of the additional protective conductor or neutral conductor are preferably closed. This enables particularly simple production and a high and lasting stability.

For example, at least one inwardly projecting projection and/or at least one lamella or contact lamella can be provided in the hollow interior of the additional protective conductor or neutral conductor. This provides a particularly secure contact and facilitates the plugging process. Furthermore, tolerances (e.g. manufacturing tolerances and/or temperature-related tolerances, etc.) can be compensated for particularly easily and the contact between the protective conductor contact and the other protective conductor contact or the neutral conductor is particularly reliable and permanent.

The protective conductor contacts are often designed as so-called leading contacts relative to the (current-carrying) contacts. As a result, the protective conductor contacts are usually longer than the (current-carrying) contacts, i.e. they protrude further from the connector housing or connector adapter. By accommodating the first protective conductor contact in the interior of the second protective conductor contact at least in sections (e.g. along a length of at least 3 mm, preferably at least 5 mm), the extent to which the second plug face protrudes from the connector can thus be reduced, which also reduces the maximum possible tilting path or angle of rotation of the electrical connection unit until it strikes against a structure or wall comprising the second socket. This also reduces the torque and the risk of the plug connection of the electrical connection unit loosening or coming loose in relation to the second socket.

Another advantage is that this creates a particularly direct and particularly current-carrying electrical connection between the two protective conductor contacts. There is only a single contact resistance (at the contact point between the two protective conductor contacts), which increases the safety of the electrical connection unit. Another advantage is that this prevents any rewiring for the protective conductor contacts in the connector adapter from becoming defective-because no rewiring is necessary at all.

The additional protective conductor contact can, for example, be designed in the form of a female contact element, e.g. a socket contact, in the region of the coupling. It can, for example, be designed in the form of a male contact element, e.g. as a pin or contact blade, on the side of the second plug face.

In a further development, it is provided that the first plug face corresponds to a NEMA 5-15 plug face, wherein the second plug face corresponds to a plug face selected from the type group: NEMA 6-15, NEMA 6-20, NEMA 10-30, NEMA 14-30, NEMA 14-50, NEMA 6-50.

This has the advantage of making the connector particularly compact, as the plug face of the NEMA 5-15 type is one of the smallest plug faces of the NEMA types listed above. The current carrying capacity of the (current-carrying) contacts and the protective conductor contact of the NEMA 5-15 plug face is sufficient for the higher voltages and maximum currents of the other NEMA connector types, although the dimensions of the NEMA 5-15 contacts (current-carrying and protective conductor) are at most as large as the dimensions of the other NEMA connector types. As a result, the connector adapter can also be designed to be particularly compact in terms of depth (along the plug-in direction) and the distance between the second plug face and the first plug face along the plug-in direction can also be kept particularly small. This is because it is only necessary to ensure that the relatively short contacts of the NEMA 5-15 plug face, which are plugged into the coupling on a first side of the connector adapter, do not protrude from the second side of the connector adapter, which is opposite the first side. The shorter the contacts of the first plug face are, the more compact the electrical connection unit can be when viewed in the plug-in direction. This advantageously reduces the maximum tilting path or angle of rotation or reduces the torque acting on the electrical connection unit in the direction of the structure or wall comprising the second socket, in particular compared to an embodiment in which, for example, the first plug face is designed as NEMA 10-30 or NEMA 14-30 or NEMA 14-50 or NEMA 6-50.

In the case of the NEMA 10-30 plug face, for example, the neutral conductor of the second plug face can be connected to the protective conductor contact of the first plug face. In this case, the two other contacts are the two contacts that are plugged together with the phase-guiding sockets of the NEMA 10-30 socket.

The proposed embodiment of the first plug face is surprising, as the connector usually has a plug face with a nominally higher load capacity as the first plug face in adapter solutions for charging cables for electric vehicles and the connector adapter has a plug face as the second plug face that is nominally designed for lower maximum currents and/or a lower maximum voltage.

In a further development, it is provided that the connector adapter has at least one encoding means which encodes the type of the second plug face, wherein the encoding means is selected in particular from the group consisting of a passive electronic component, in particular a resistor, a coil, a capacitor; an encoding pin; an encoding rib; an encoding cut-out; an encoding groove; a magnet; an electronic signature, in particular communicable contact-based or contactless by means of RFID, NFC, Bluetooth®, WLAN, optical; a QR code.

This advantageously ensures that the connector or that electrical and/or electronic components of the connector can be automatically set in a simple manner to the parameters associated with the respective connector adapter, e.g. to a maximum possible voltage and/or a maximum possible current.

Mechanical encoding devices are advantageously less susceptible to faults. Passive electrical or electronic components can be installed particularly easily and inexpensively and do not require a power supply for active operation (in contrast to an ASIC or the like, for example). Electronic signatures advantageously make it possible to transmit a wide range of information, so that, for example, serial numbers, operating times or the like can also be transmitted with little effort. At the same time, electronic signatures do not necessarily require wired or cabled transmission; wireless transmission can also be enabled, which can improve the tightness of the connector adapter and/or the connector, for example (no feed-throughs or sockets or plug contacts are required). A magnet also allows information to be transmitted (magnet present or not or defined magnetic strength and/or magnetic field alignment), which can be wireless and thus improves the tightness of the connector adapter and/or the connector.

Encoding by means of an electronic signature can, for example, be stored in a memory module or result from a characteristic (natural) frequency during excitation. It is possible, for example, for the electronic signature to be transmitted optically, e.g. via infrared radiation or the like.

For example, it can be provided that the encoding means is arranged on or in the region of a first side of the connector adapter comprising the coupling. It can, for example, be arranged in the overlapping region of the holder that has the first plug face, or be located opposite the holder surface of the holder. This creates a particularly compact design for the connector adapter.

In a further development, it is provided that the connector is set up to detect or determine the type of the second plug face by means of the encoding means of the connector adapter, wherein the connector has a first electronic circuit which is set up to control or adjust the power or voltage that can be transmitted via the connector, in particular the maximum power or voltage that can be transmitted, as a function of the detected type of the second plug face.

This has the advantage that the connector enables a particularly safe and reliable charging and discharging process.

It is understood that a detection means can be provided for detection in the connector. By way of example only, this can be an electrical and/or electronic and/or magnetic and/or mechanical component which is set up to detect the socket type encoded by the encoding means or the type of the second plug face.

Alternatively or additionally, it is provided that the electronic circuit is set up to transmit or send the detected or determined type of the second plug face to a second electronic circuit of the connector or the charging cable.

This enables a particularly safe and reliable charging and discharging process.

The second electronic circuit can, for example, be a control unit, e.g. a control unit as described below.

According to a second aspect of the invention, a charging cable for supplying a vehicle with electrical energy or for extracting electrical energy from the vehicle is proposed.

The charging cable has a connector or an electrical connection unit as described above, it also has a further connector which is set up to be electrically coupled to the vehicle and it has a connecting line which is detachably or non-detachably coupled to the connector and the further connector.

This provides a charging cable that advantageously does not require an ICCB when it is connected to a socket, in particular a household socket, using the connector. This makes the charging cable particularly cost-effective, lightweight and space-saving, and reduces the risk of tripping on the floor. Another advantage is that the charging cable can be connected to different types of sockets with a single connector and using the connector adapter, without having to use multiple connectors. This eliminates the need for the user to purchase multiple connectors for different types of sockets, which is costly, and the user saves space, e.g. in the trunk of their vehicle. The proposed charging cable is also advantageously designed to be particularly robust against loosening or disengagement of the connector or the electrical connection unit from the socket, wherein this applies in particular to a plurality of different socket types. This enables particularly safe operation and increases the service life of the proposed charging cable.

In a further development, it is provided that the further connector has a control unit for controlling the flow of electrical current through the charging cable, in particular when the connector is connected to a household socket or connected (in particular electrically connected) to a household socket or a socket without control lines, wherein the further connector has a bypass switch which is set up to optionally bypass the control unit or to connect it to a control line of the connecting line, wherein the bypass switch connects the control unit to the control line in particular when a voltage from a voltage supply of the connector is present.

This enables safe operation of the charging cable when it is connected to a household socket. An ICCB can be advantageously dispensed with, so that the charging cable is particularly light and compact and the risk of tripping is reduced. Another advantage is that the weight of the connector is reduced by distributing the electrical and/or electronic components to the other (vehicle-side) connector and to the connector (infrastructure-side or household-side). This makes the connector particularly secure against loosening or loosening of the plug connection, as less torque acts on it.

Another advantage is that the charging cable can be used in this modular way when replacing the connector for connecting to a household socket with another connector that can be connected to a wallbox, for example. If the other connector is connected to the connecting line or supply line of the charging cable, for example, the bypass switch is not activated and the control unit, for example, is bypassed. In this way, the vehicle connected to the charging cable can negotiate the charging process directly with the power source (e.g. the wallbox); the control unit in the vehicle's additional connector is not required. If the connector for connecting to a household socket is coupled to the connecting line, the bypass switch can be activated when the connector is connected to a socket (in particular to a household socket or a socket without signal line(s) and/or without control line(s)), thereby activating the control unit, for example. As the vehicle connected to the charging cable cannot negotiate the charging process with the (household) socket as such, this process is now carried out by the control unit in the other (vehicle-side) connector.

It is understood that in other embodiments, all electrical and/or electronic components can also be arranged in the (infrastructure-side) connector (in particular for connection to a household socket).

In yet another embodiment, it can be provided that all electrical and/or electronic components are arranged in the (vehicle-side) further connector.

The location of the electrical and/or electronic components is not essential for the configuration of the electrical connection unit of the charging cable.

According to a third aspect of the invention, a connector adapter for a connector of a charging cable or a connector adapter for coupling with a connector of a charging cable is proposed.

The connector adapter has a coupling for coupling with a first plug face of the connector. The first plug face is set up for coupling with a first socket shape of a first socket. The connector adapter has a second plug face for connecting to a second socket having a second socket shape different from the first socket shape, wherein the second plug face is offset essentially perpendicular to a mounting direction of the connector adapter relative to the coupling.

This advantageously provides a connector adapter which has a particularly compact design and which, when mounted on a corresponding connector, produces a particularly low torque in the case connected to the second socket. This means that the plug connection is particularly well protected against loosening and/or disconnection.

For example, it can be provided that the coupling and the second plug face overlap by no more than 25% of their respective surfaces.

For example, the connector adapter can be plugged directly onto the first plug face.

Alternatively or in addition to the offset of the second plug face and coupling, it is provided that the at least two further contacts (of the connector adapter) are arranged closer to the second end of the connector relative to the at least two contacts (of the connector) and the protective conductor contact (of the connector) is arranged between the at least two contacts and the at least two further contacts, in particular viewed along a line extending from the first end to the second end (of the connector).

In a further development, it is provided that the coupling and the second plug face in opposite directions.

This enables a particularly compact design of the connector adapter. Furthermore, the extent of any necessary rewiring within the connector adapter can be advantageously kept to a minimum. This increases the service life of the connector adapter, simplifies the removal of heat during operation and increases safety.

In a further development, it is provided that the connector adapter has an adapter housing with a first side and a second side facing away from it, wherein the coupling is formed on or on the first side of the adapter housing, wherein the second plug face is formed on or on the second side of the adapter housing.

The adapter housing gives the connector adapter a defined shape and high stability. Another advantage is the particularly compact design of the connector adapter. Furthermore, the extent of any necessary rewiring within the connector adapter can be advantageously kept to a minimum. This increases the service life of the connector adapter, simplifies the removal of heat during operation and increases safety.

For example, it can be preferable for the connector adapter to have exactly one single coupling.

For example, it can be preferable for the connector adapter to have exactly one single plug face.

### BRIEF DESCRIPTION OF THE DRAWINGS

Further features and advantages of the present invention will be apparent to the skilled person based on the following description of exemplary embodiments with reference to the accompanying drawings, but these are not to be construed as limiting the invention.

The following is shown in the images:

FIG. 1: a schematic representation of a charging cable;

FIGS. 2a and 2b: schematic representations of a charging cable and the electrical and/or electronic elements in the associated connectors;

FIG. 3: a schematic view of a connector of a charging cable plugged into a household socket;

FIGS. 4a-4g: schematic representations of various NEMA socket shapes and NEMA plug faces;

FIG. 5: a schematic perspective view of a charging cable and two different infrastructure-side connectors for connection to two different types of sockets;

FIG. 6: a schematic representation of a connector for a charging cable with a connector adapter from the prior art;

FIG. 7: a schematic representation of an electrical connection unit;

FIGS. 8a and 8b: schematic side views of an electrical connection unit in two different mounting states of the connector adapter;

FIGS. 9a and 9b: schematic views of an electrical connection unit in two different mounting states of the connector adapter;

FIGS. 10a and 10b: schematic perspective views of an electrical connection unit in two different mounting states of the connector adapter;

FIG. 11: a schematic perspective view of a connector with a first plug face without connector adapter;

FIGS. 12a-12c: various perspective views of a connector adapter for coupling with a connector of a charging cable;

FIG. 13: a schematic perspective view of a charging cable with a connector on the infrastructure side for connection to a household socket without a connector adapter and with a further connector on the vehicle side.

### DETAILED DESCRIPTION

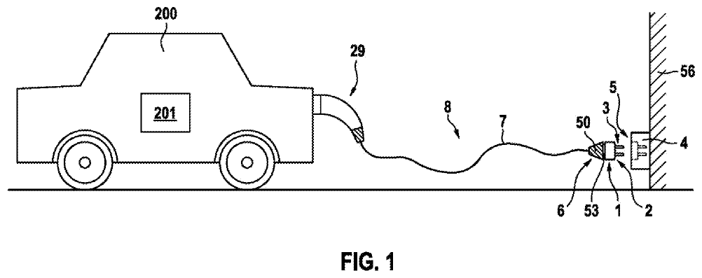

FIG. 1 shows a schematic representation of a charging cable 8 for supplying a vehicle 200 with electrical energy or for extracting electrical energy from the vehicle 200. The vehicle 200 has an energy storage device 201, in particular an electrical energy storage device 201, in particular a battery, in particular a high-voltage battery with a voltage of more than 40V, preferably more than 100V.

The charging cable 8 has a connector 1 (on the infrastructure side). The connector 1 has a first end 2 or generally a first section with a first plug face 3, set up for connection to a first socket 4 with a corresponding first socket shape 5. The first socket 4 is arranged here exemplarily in or on a structure, here exemplarily in a wall 56. The first socket 4 can be a household socket, for example. The connector 1 also has a second end 6 for detachable or non-detachable coupling with a connecting line 7 of the charging cable 8. In the embodiment example shown, the connector 1 is detachably attached to the connecting line 7. For this purpose, the connecting line 7 has a connecting line coupling 50 and the connector 1 has a connector coupling 53 at its second end 6, which can be coupled to the connecting line coupling 50. It can be removed non-destructively from the connecting line 7 by disconnecting it and another connector, e.g. for connecting to a wall box, with a different plug face (e.g. type 1 plug face or type 2 plug face or the like) can be connected to the connecting line 7.

It is understood that the connector 1 can also be connected to the connecting line 7 in a non-detachable (non-destructively detachable) manner.

At the other end of the connecting line 7, the charging cable 8 has a further connector 29, which is set up to be electrically coupled to the vehicle 200. In FIG. 1, the further connector 29 is electrically coupled or connected to the vehicle 200. Like the first connector 1, the other connector 29 can be detachably or non-detachably coupled to the connecting line 7.

In principle, a socket can also be attached to the connecting line 7 instead of the connector 1. In this case, current can flow from the energy storage 201 of the vehicle 200 in the direction of the socket, i.e. current or energy is then drawn from the energy storage 201 of the vehicle 200. This is possible with bidirectional charging. The charging cable 8 is therefore generally a supply cable. For better readability, however, the term charging cable is used in the context of the application.

For a charging process of the energy storage unit 201, it is necessary for an electronic system of the vehicle 200, which is not shown in detail here, to exchange signals with another electronic system, for example in order to exchange information about the maximum available current and/or voltage. When connected to a wallbox or a public charging station, the additional electronics are often located in the wallbox or charging station. The vehicle 200 then communicates with the wallbox or charging station via one or more signal lines of the charging cable, for example. However, if the charging cable 8 with its connector 1 is connected to a household socket, a three-phase connection or the like, no further electronics are usually provided there for communication with the vehicle. In the prior art, this task is performed by another electronic system or a control unit, which is arranged in the supply line 7 (there in a so-called ICCB, “In Cable Control Box”). In the charging cable shown in FIG. 1, however, the other electronics are distributed over the connector 1 and the other connector 29, so that the ICCB can be dispensed with.

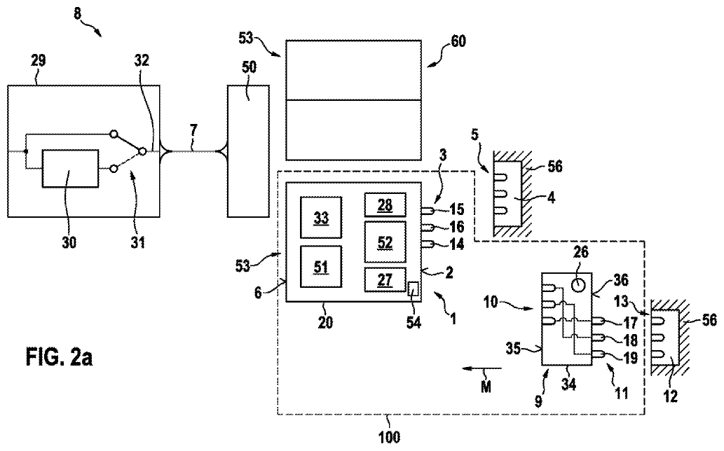

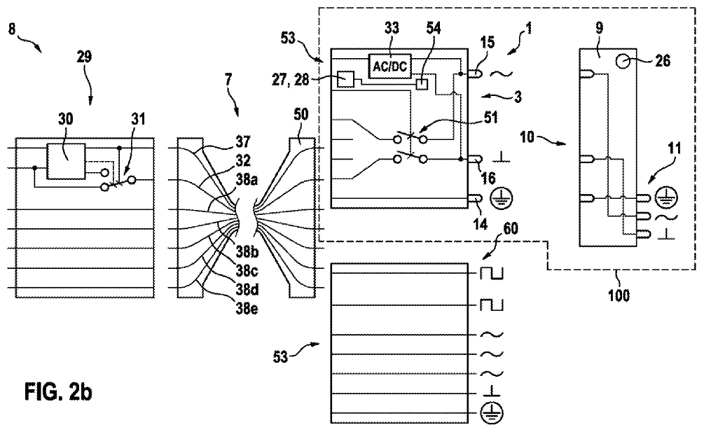

FIG. 2a schematically shows a charging cable 8 with electrical and/or electronic elements in the associated connectors 1, 29, 60. For the configuration of the electrical connection unit 100, FIG. 2a is described below with reference to other figures.

As in FIG. 1, the charging cable 8 has a connecting line 7. The right-hand side of FIG. 2a shows a connector 1 for connecting to a socket, which can be a household socket, for example. In addition, an infrastructure connector 60 is shown, which can be designed, for example, as a type 1 connector or as a type 2 connector or the like and which can be set up, for example, to be connected to a wallbox or a public charging station or a charging point.

Both the connector 1 (in particular for sockets without signal contacts) and the infrastructure connector 60 (in particular for sockets with signal contacts) have a connector coupling 53, with which they can be coupled to a connecting line coupling 50 of the connecting line 7 in a non-destructive, detachable manner. At the other end of the connecting line 7, a further connector 29 is provided on the vehicle.

In this example, the infrastructure connector 60 has only a few or no electronic and/or electrical components.

The further connector 29 has a control unit 30 for controlling the flow of electrical current through the charging cable 8, in particular when the connector 1 is connected to a household socket or connected to it. The further connector 29 furthermore has a bypass switch 31, which is set up to optionally bypass the control unit 30 or to connect it to a control line 32 of the connecting line 7, wherein the bypass switch 31 connects the control unit 30 to the control line 32 in particular when a voltage from a voltage supply 33 of the connector 1 is present.

The power supply 33 can be designed as a voltage transformer, for example. For example, after connecting the connector 1 to the socket, it can convert a phase voltage of the socket into a direct current (or into an alternating current) (e.g. in the range between 5V and 30V), which is then conducted via a (signal) line or a (further) control line 37 (see e.g. FIG. 2b) of the connecting line 7 to the further connector 29 and there can actuate the bypass switch 31 directly or indirectly in such a way that the control unit 30 can communicate with the vehicle 200, e.g. by removing a bypass of the control unit 30 by the bypass switch 31.

The (infrastructure-side) connector 1 also has at least one switching unit 51 (e.g. a relay) with which the current flow through the connector 1 can be disconnected.

In this respect, the charging cable 8 and the connectors 1, 29, 60 are designed similarly to those described in detail in DE 10 2021 203 363 A1 referred to.

As an example, the connector 1 also has a temperature monitoring module 52. This can be set up, for example, to reduce or switch off the current flow through connector 1 when a temperature is detected that is above a setpoint value. Such a current reduction or switch-off can be carried out, for example, by the temperature module 52 itself or by another element (e.g. the control unit 30) which is connected to the temperature module 52.

FIG. 2a also shows a connector adapter 9, which has a coupling 10 for coupling with the first plug face 3 of the connector 1. The first plug face 3 (without connector adapter 9) is set up for connection to a first socket shape 5 of a first socket 4. The connector adapter 9 also has a second plug face 11 for connection to a second socket 12 with a second socket shape 13, which is different from the first socket shape 5. The connector adapter 9 can be coupled to the first plug face 3 of the connector 1 by means of the coupling 10 (in FIG. 2a it is still shown separately from the connector 1), in particular it can be plugged directly onto the first plug face 3. This coupling of the connector adapter 9 with the connector 1 takes place, for example, along a mounting direction M. The second plug face 11 is offset essentially perpendicular to the mounting direction M of the connector adapter 9 relative to the coupling 10. In order to effect this offset, rewiring can be provided in the connector adapter 9 (see the lines drawn from the socket contacts of the coupling 10, exemplified here, to the pin contacts of the second plug face 11, exemplified here, which are intended to symbolize electrical lines).

The coupling 10 is to be understood hereby in particular as that part or that section of the connector adapter 9 which couples directly mechanically and electrically with the contacts of the first plug face 3. The mechanical attachment of the connector adapter 9 to the connector 1 can be different from this, e.g. a coupling latch or a coupling screw connection can also be provided. The offset between coupling 10 and second plug face 11 thus refers to the relative geometric arrangement of the electrical components (e.g. the offset between the sockets (openings) of coupling 10 and the pins of second plug face 11).

The coupling 10 and the second plug face 11 point in opposite directions in this example (in FIG. 2a, the coupling 10 points to the left, the second plug face 11 to the right).

The connector adapter 9 has here, by way of example, an adapter housing 34 with a first side 35 and a second side 36 facing away therefrom, wherein the coupling 10 is formed on or in the first side 35 of the adapter housing 34, wherein the second plug face 11 is formed on or in the second side 36 of the adapter housing 34.

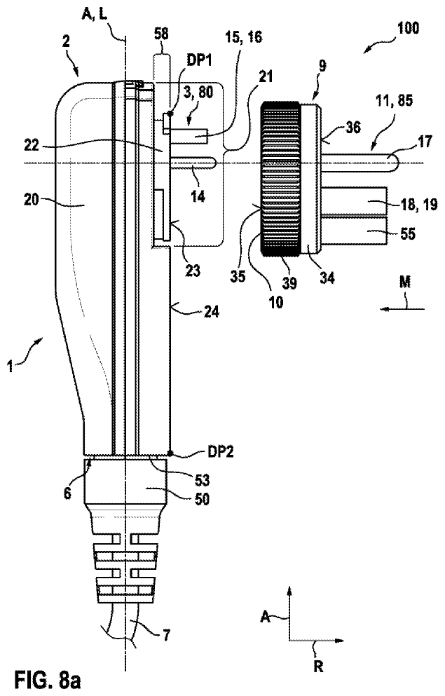

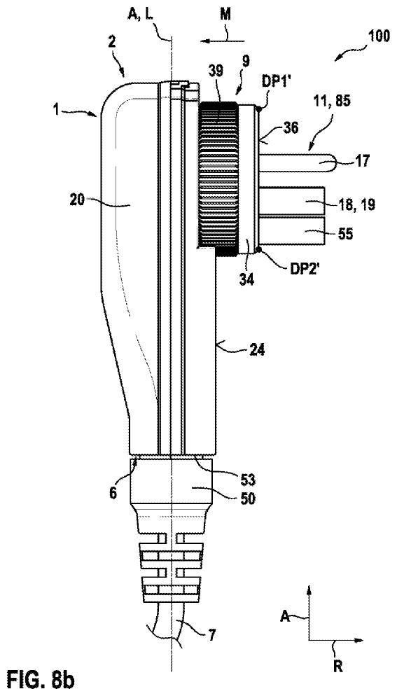

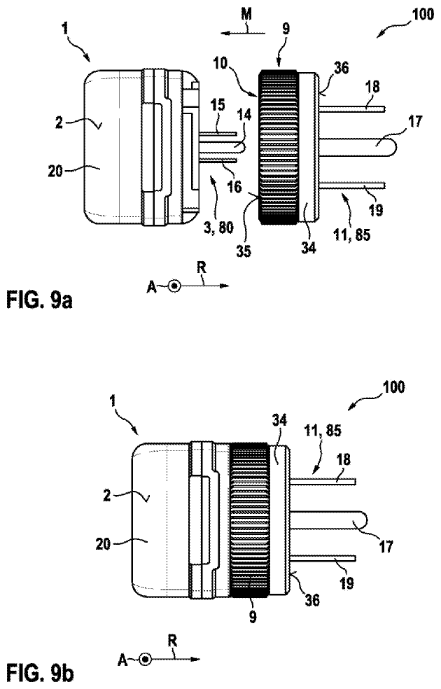

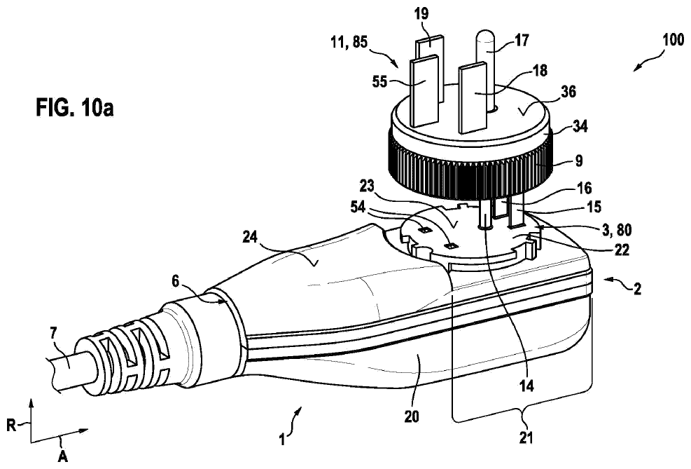

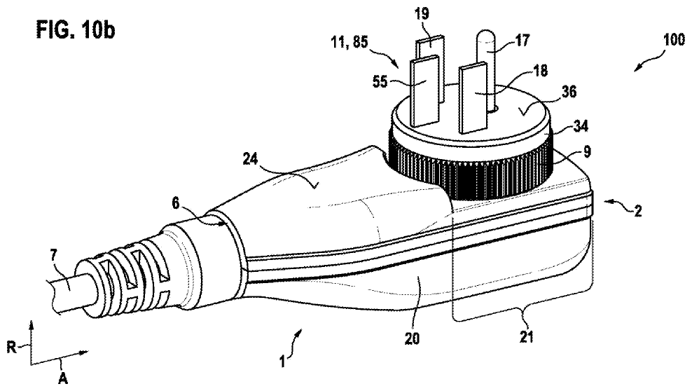

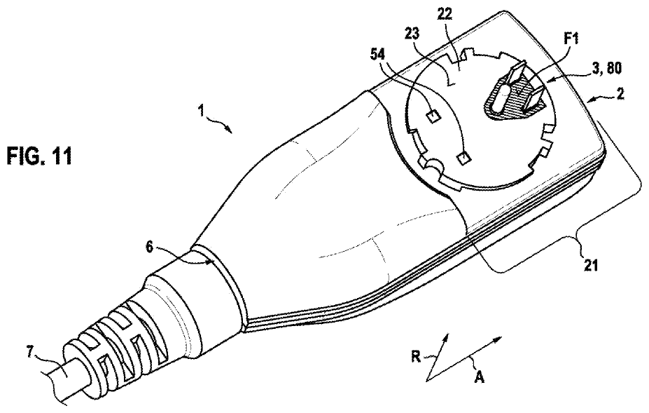

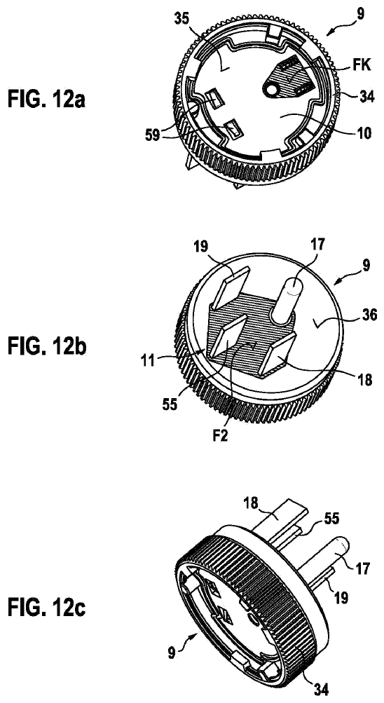

The first plug face 3 has a protective conductor contact 14 and at least two, in particular current-carrying, contacts 15, 16 (see in detail e.g. FIGS. 9a, 10a, 11), wherein the second plug face 11 has here, by way of example, a further protective conductor contact 17 and at least two further, in particular current-carrying, contacts 18, 19 (see e.g. FIGS. 10, 10b, 12b). In a state in which the connector adapter 9 is mounted on the connector 1, the second plug face 11 is offset essentially perpendicular to the mounting direction M of the connector adapter 9 relative to the first plug face 3. This offset can, for example, be designed in the direction of the second end 6 or the second section of the connector 1 (see, for example, FIGS. 8a and 8b). The coupling 10 and the second plug face 11 overlap by no more than 25% of their respective surfaces FK, F2 (see FIGS. 11, 12b).

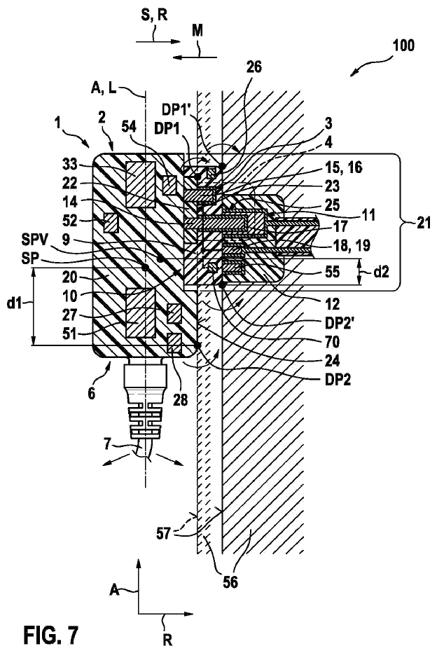

As an example, alternatively or simultaneously, the at least two further contacts 18, 19 of the connector adapter 9 can also be arranged closer to the second end 6 or closer to the second section of the connector 1 or of the connector housing 20 relative to the at least two contacts 15, 16 of the connector 1, and the protective conductor contact 14 can be arranged between the at least two contacts 15, 16 and the at least two further contacts 18, 19, in particular viewed along a line L that extends from the first end 2 or first section to the second end 6 or second section (see e.g. FIGS. 7, 8a, 8b).

Connector 1 and connector adapter 9 together form an electrical connection unit 100.

In this example, the connector adapter 9 has at least one encoding means 26, which encodes the type of the second plug face 11. The encoding means 26 can, for example, be selected from the group: a passive electronic component, in particular a resistor, a coil, a capacitor; an encoding pin; an encoding rib; an encoding recess; an encoding groove; a magnet; an electronic signature, in particular one that can be transmitted or emitted contact-bound or contactless by means of RFID, NFC, Bluetooth®, WLAN, optical; a QR code.

In this example, the connector 1 is set up to detect the type of the second plug face 11 by means of the encoding means 26 of the connector adapter 9. For this purpose, the connector 1 has a first electronic circuit 27, which is set up to control and/or regulate and/or adjust the power or voltage that can be transmitted via the connector 1, in particular the maximum power or voltage that can be transmitted, as a function of the detected type of the second plug face 11. The first electronic circuit 27 is also set up here, by way of example, to transmit the detected type of the second plug face 11 to a second electronic circuit 28 of the connector 1. The second electronic circuit 28 can, for example, form a redundancy for setting the maximum power to be transmitted. However, in other embodiment examples, it can also be provided that the first electronic circuit 27 only transmits the data relating to the second plug face 11 and the control of the maximum power to be transmitted is then only carried out by the second electronic circuit 28. It can further be provided (not shown here) that the second electronic circuit corresponds to the control unit 30 in the further connector 29, so that the first electronic circuit 27 transmits the determined or detected type of the second plug face 11 to the control unit 30. The setting or regulation or control of the maximum possible power or the maximum possible current or the intended voltage can then be carried out by the control unit 30 as a function of the transmitted or received data relating to the type of the second plug face 11.

The second electronic circuit 28 can in principle be arranged on or in any element of the charging cable 8, e.g. in the connecting line 7 or in the further connector 29.

FIG. 2b shows a further schematic representation of the charging cable 8, wherein the individual electrical lines are shown here.

The electrical functions and the cable routing are similarly described in DE 10 2021 203 363 A1, to which reference is made.

By way of example, four (current-carrying) lines 38a, 38b, 38c, 38d (three of which are phase lines, one is a neutral conductor), as well as a protective conductor line 38e are provided, which are set up, for example, to be able to transmit powers of more than 1 kW. Furthermore, a control line 32 and a further control line 37 are provided, both of which are primarily intended for signal transmission.

In the connector 1, the first electronic circuit 27 and the second electronic circuit 28 are assigned, by way of example, to an element which may, for example, be an integrated component. The power supply 33 is shown here as an AC/DC converter.

In the connector adapter 9, the rewiring that enables the offset of coupling 10 and second plug face 11 is clearly visible.

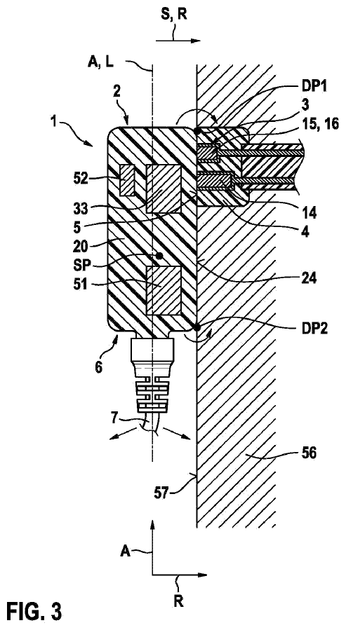

FIG. 3 shows a schematic view of a connector 1 of a charging cable 7, which is plugged into a household socket, wherein this household socket is designed here as a first socket 4 with a first socket shape 5. In this example, the first socket 4 is arranged in a wall 56 and has the first socket shape 5 in an outer wall surface 57 of the wall 56. The connector 1 has a similar design to the connectors 1 described above.

The connector 1 is plugged into the first socket 4 in such a way that its first end 2 or a first section in FIG. 3 points upwards and its second end 6 or its second section and the connecting line 7 point downwards. A longitudinal axis A of the connector 1 or the connector housing 20 runs from bottom to top in FIG. 3, defining an axial direction. A line L, which runs from the first end 2 or first section to the second end 6 or second section, extends essentially parallel to the longitudinal axis A in this example. A radial direction R runs perpendicular to the longitudinal axis A. The first plug face 3 is formed here parallel to the radial direction R and points to the right in FIG. 3, towards the wall 56. A plug-in direction S, along which the connector 1 is plugged into the first socket 4, runs here, for example, from left to right, i.e. here, for example, parallel to the radial direction R. In particular, it can be provided that the gravity in FIG. 3 points downwards.

The connector 1 has a connector housing 20, which has a wall 24 facing the outer wall surface 57. In the inserted state of the connector 1, this wall 24 lies flat against the wall 56 or the outer wall surface. The connector 1 has a center of gravity SP.

The connector housing 20 is flat, its extension along the longitudinal axis A is here exemplarily at least twice as large as its depth or width in the radial direction R. The electrical and electronic components inside the connector housing (e.g. the power supply 33, the switching unit 51, the temperature monitoring module 52, the first and second electronic circuits 27, 28 (not visible in this section), etc.) are thus arranged close to the wall 56, as a result of which the center of gravity SP is close to the wall 56.

An undesired loosening or loosening of the plug connection between the connector 1 and the first socket 4 can be caused, for example, by the weight of the connector 1 and the additional weight of the connected connecting line 7, since this can exert a torque on the connector 1—e.g. by mentally engaging the center of gravity SP-which rotates the first plug face 3 out of the first socket shape 5. Other causes for loosening or loosening of the plug connection can be a wobbling of the connecting line 7 in FIG. 3 to the left or right, indicated by the two arrows in the region of the connecting line 7.

All these influences (dead weight, mechanical influences such as wobbling on the connecting line 7, etc.), which lead, for example, to a torque on the connector 1, can cause a rotation of the connector 1 or of the connector housing 20 about a first pivot point DP1 (here exemplified at the contact point of the connector housing 20, e.g. at the first end 2 with the wall 56) and/or about a second pivot point DP2 (here exemplified at the contact point of the connector housing 20, e.g. at the second end 6 with the wall 56). The rotation around the two pivot points DP1, DP2 is illustrated by the arrows near the respective pivot point DP1, DP2. It should be noted that the dead weight of the connector 1 without any other influences ultimately only causes it to rotate about the second pivot point DP2 (gravity acts downwards in this example).

Due to the long, flat connector housing 20, which lies flat against the wall 56, and the clever arrangement of the electrical and electronic components inside the connector housing 20, the center of gravity SP is on the one hand close to the wall 56 and also, viewed along the longitudinal axis A, between the first pivot point DP1 and the second pivot point DP2. This greatly reduces the torque acting on the plug connection and minimizes the risk of the connector 1 coming loose from the first socket 4 despite its weight.

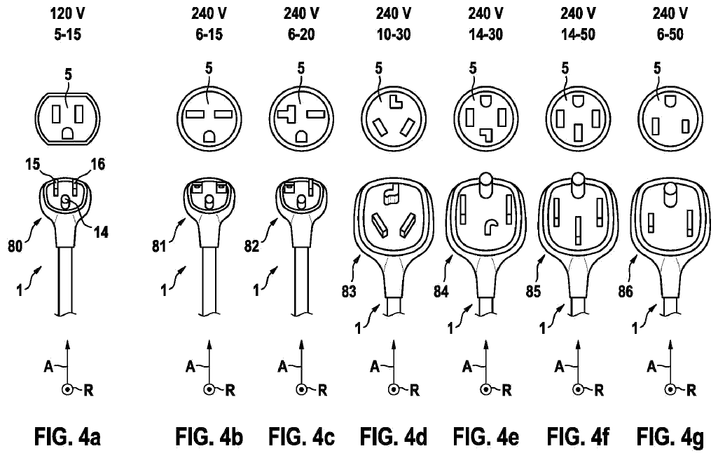

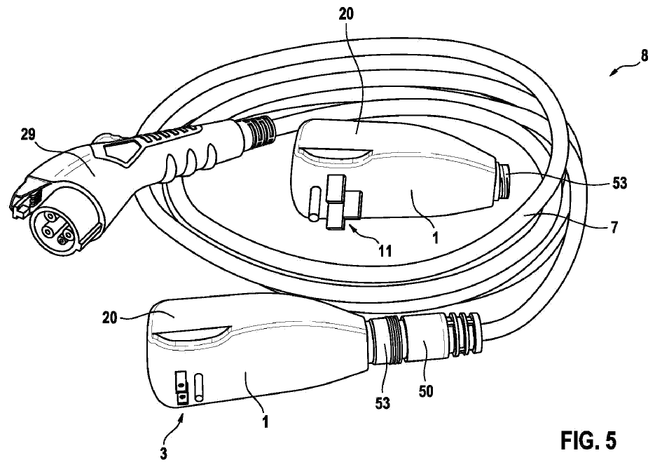

The upper part of FIG. 4a shows a schematic representation of a NEMA 5-15 socket shape of a (household) socket, as found in households in the USA, for example. The lower part shows the plug face of a complementary connector (NEMA 5-15, reference number 80). The NEMA 5-15 plug or NEMA 5-15 socket is a type to which a voltage of approx. 120V is normally applied (two current-carrying contacts 15, 16: one phase conductor and one neutral conductor, both designed as flat contacts) and which should normally provide a maximum current of 15 A. A protective conductor contact 14 is also provided, which is designed here as a round contact.

FIGS. 4b through 4g show other NEMA socket shapes commonly used in the USA in the upper part and the corresponding plug faces in the lower part. All types shown here are designed for a voltage of 240V and can provide currents between 15 A and 50 A. The following types are shown here as examples only: NEMA 6-15 (FIG. 4b, 81), NEMA 6-20 (FIG. 4c, 82), NEMA 10-30 (FIG. 4d, 83), NEMA 14-30 (FIG. 4e, 84), NEMA 14-50 (FIG. 4f, 85), NEMA 6-50 (FIG. 4g, 86). Some of these types have two phase conductors. The individual performance data and geometric data are publicly available and are therefore not described in detail here.

In the case of the NEMA 10-30 type, only a neutral conductor is provided and no protective conductor as such. There are also two phase-carrying cables in the socket.

The presentation of the various NEMA types is merely intended to illustrate that a large number of mechanically incompatible plug types can already exist in a single country (USA). The invention is not limited to the connector types shown and, in particular, is not limited to NEMA connectors.

FIG. 5 shows a schematic perspective view of a charging cable 8 with a further (vehicle-side) connector 29, a connecting line 7 and two different (infrastructure-side) connectors 1 for connection to two different (household) socket types on the one hand and for coupling with the connecting line 7 on the other. The arrangement of electrical and electronic components in the (infrastructure-side) connector 1 as described above means that there is no need for an ICCB in the charging cable 8. On the other hand, connector 1 is slightly larger than a standard household connector. If, for example, the charging cable 8 is to be connectable to two different socket types (e.g. NEMA 5-15 and NEMA 14-50) in the USA, either two charging cables 8 are required or one charging cable 8 to which two different connectors 1 can be connected (as shown in FIG. 5). However, this is expensive and space-consuming for the user, who now has to buy and store two connectors.

Another alternative is to provide an adapter that is mounted on the first plug face 3 of the connector 1.

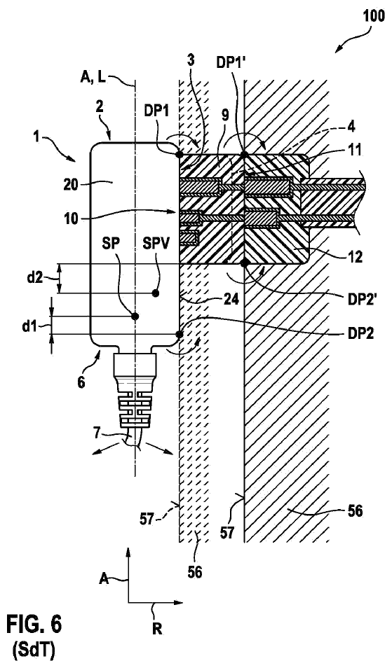

FIG. 6 shows a schematic representation of a connector 1 for a charging cable 8 with a connector adapter 9 from the prior art. The connector adapter 9 has a coupling 10 and a second plug face 11, wherein the connector adapter 9 is mounted with the coupling 10 on the first plug face 3. The first plug face 3 and the second plug face 11 are aligned hereby. Furthermore, the connector 1 has no or only a few electrical and/or electronic components (e.g. a temperature sensor can be provided, but not relays or voltage converters), as it is intended for a charging cable with ICCB, which has the heavy electrical and/or electronic components in terms of weight.

The first plug face 3 is designed here as a NEMA 14-50 connector. The connector adapter 9 is set up to enable connection to a socket with a lower voltage (e.g. 100V to 130V). For example, it can have a second plug face 11 of the NEMA 5-15 type.

FIG. 6 shows both the state without connector adapter 9 (dashed wall 56 and dashed first socket 4, which is only shown schematically here without sockets) and the state with mounted connector adapter 9 (solid wall 56 and second socket 12). The main purpose of this illustration is to show the mechanical effects when using the connector adapter 9.

It is easy to see that the center of gravity SP of the connector 1 without the connector adapter 9 lies between the first pivot point DP1 and the second pivot point DP2 (viewed along the axial direction or the longitudinal axis A), the connector 1 also rests against the wall 56 with a wall 24 of its connector housing 20. The position of the center of gravity SP in the plugged-in state can, for example, also be shifted in the direction of the connecting line 7 due to the weight of the connecting line 7 and/or a connector coupling n that can be present. The torque acting on the plug connection is therefore relatively low and the risk of loosening or loosening is also low. In addition, the NEMA 14-50 standard has three current-carrying contacts (two of which are visible) and a protective conductor contact (the top contact in FIG. 6), so that any pull on the plug is distributed over four contacts, which are quite far apart and have large dimensions.

If the connector adapter 9 is now mounted, the connector housing 20 moves away from the wall 56, since the connector adapter 9 has a certain depth along the mounting direction M. Due to the large or long pins of the NEMA 14-50 plug face of connector 1, the depth of the connector adapter 9 cannot be reduced. The plug-in connector adapter results in a new first pivot point DP1′ and a new second pivot point DP2′. In addition, this results in a shifted center of gravity SPV, which in FIG. 6 (gravity pointing downwards) is shifted a little upwards and towards the wall 56 due to the attached connector adapter 9 compared to the center of gravity SP of the connector 1 without connector adapter 9.

However, the shifted center of gravity SPV is now below the new second pivot point DP2′ and therefore no longer between the two new pivot points DP1′, DP2′. Furthermore, the second plug face 11 now only has two current-carrying contacts (one of which is visible, at the bottom) and one protective conductor contact (the top contact in FIG. 6).

FIG. 6 shows a first distance d1 from the center of gravity SP to the second pivot point DP2 as well as a second distance d2 from the displaced center of gravity SPV to the new second pivot point DP2′. The second distance d2 is negative in relation to the second new pivot point DP2′, i.e.: the displaced center of gravity SPV lies below the new second pivot point DP2′ and thus outside the pivot surface spanned by the two new pivot points DP1′, DP2′.

This makes the entire electrical connection unit 100 consisting of connector 1 and connector adapter 9 (more) unstable and, without further support measures, the plug connection can loosen or even come loose much more quickly. This is because the electrical connection unit 100 is now heavier than the connector 1. The displaced center of gravity SPV is located below the new second pivot point DP2′ The tilting path until the connector housing 20 touches the wall 56 and thus stops the release is very large due to the great depth of the connector adapter 9 and hardly prevents the plug connection from being released. In addition, the second plug face 11 is less splayed (i.e. has a smaller surface) than the first plug face 3 and also has only three contacts and no longer four contacts. The three contacts also have a shorter length and smaller widths and thicknesses than the four contacts of the NEMA 14-50 standard. This significantly increases the risk of the plug connection coming loose when using the connector adapter 9 from the prior art.

FIG. 7 shows in comparison a schematic representation of an electrical connection unit 100 that overcomes these disadvantages.

The electrical connection unit 100 is designed similarly to FIGS. 1, 2a and 2b above with regard to its connector 1 and the connector adapter 9. In particular, the connector 1 has electrical and/or electronic components as described above. In particular, it is designed in such a way that an ICCB can be dispensed with in the charging cable 8. As a result, it can have a higher weight and larger dimensions than the connector 1 from the prior art described above in connection with FIG. 6.

In FIG. 7, as in FIG. 6, a state is shown with a dashed wall 56 in which the connector 1 is plugged into a first socket 4 (shown only schematically with a dashed line) without the connector adapter 9, and a state is shown with a solid line for the wall 56 in which the connector adapter 9 is mounted on the connector 1. The first socket 4 can be a NEMA 5-15 socket, for example. The first plug face 3 can be designed as a NEMA 5-15 plug face. As in FIG. 6, FIG. 7 also focuses in particular on the mechanical effects.

Surprisingly, it has been shown that the current-carrying capacity of the contacts 15, 16 and the protective conductor contact 14 of a NEMA 5-15 plug face is sufficient to safely conduct the power of another NEMA standard, such as the NEMA 14-50 standard (240V, maximum 50 A), if single-phase operation is used. Surprisingly, it has been shown that using the geometric dimensions of the NEMA 5-15 standard, the contacts 15, 16 and the protective conductor contact 14 can be designed in such a way that they also have sufficient current carrying capacity for single-phase transmitted power of another NEMA standard such as NEMA 14-50.

A solid line shows a wall 56 in which a second socket 12 is arranged. The connector 1 is mounted in this by means of the connector adapter 9 mounted on it. The second socket can be a socket type according to NEMA 6-15, NEMA 6-20, NEMA 10-30, NEMA 14-30, NEMA 14-50 or NEMA 6-50, for example. The second plug face 11 of the connector adapter 9 has a corresponding design.

In this example, the connector 1 has a connector housing 20 which extends along the longitudinal axis A, wherein the first plug face 3 projects from the connector housing 20 in the radial direction R perpendicular to the longitudinal axis A, wherein the connecting line 7 is coupled along the longitudinal axis A to the connector housing 20.

The connector housing 20 has a recessed section 21 at the first end 2 or in the first section, wherein the recessed section 21 is designed to accommodate the connector adapter 9, wherein the first plug face 3 is formed on or in a holder 22 in the recessed section 21, wherein in particular a holder surface 23 of the holder 22 facing the socket 4 is essentially aligned with a wall 24 of the connector housing 20 facing the socket 4 and adjoining the recessed section 21.

The holder 22 is spaced apart from the wall 24 adjacent to the recessed section 21, in particular when viewed in axial direction A.

The protective conductor contact 14 of the first plug face 3 is only aligned with the other protective conductor contact 17 of the second plug face 11 by way of example. In principle, it is also possible that the two protective conductor contacts 14, 17 are not aligned.

By way of example only, it is also provided here that the further protective conductor contact 17 is hollow at its end 25 facing the protective conductor contact 14 and the protective conductor contact 14 is plugged into the further protective conductor contact 17. In this example, the outer wall of the protective conductor contact 14 makes contact with an inner wall of the hollow further protective conductor contact 17. In this example only, the other protective conductor contact 17 is cup-shaped (with a circumferentially closed wall), wherein a partially open wall or a wall that is slotted at least in sections is also possible. The other protective conductor contact 17 is hollow along almost its entire length-merely as an example. In this example, the protective conductor contact 14 protrudes (inside the additional protective conductor contact 17) into the second socket 12 or into the socket that is assigned to the additional protective conductor contact 17. In principle, it is possible that at least one (contact) lamella and/or at least one inwardly projecting projection is provided in the hollow interior of the additional protective conductor contact 17, which can further improve contacting.

On the one hand, such a hollow design makes it possible to establish a direct, immediate contact between the two protective conductor contacts 14, 17 with a low contact resistance. In addition, the width or depth of the connector adapter 9 (here: in radial direction R, pointing from left to right in FIG. 7) can be reduced as a result, so that the electrical connection unit 100 is closer to the wall 56 in the state connected to the second socket 12. This reduces the risk of the plug connection loosening or coming loose.

The electrical connection unit 100 in FIG. 7 also has new pivot points DP1′, DP2′ and a shifted center of gravity SPV compared to the connector 1 without the connector adapter 9 fitted.

The connector housing 20 also protrudes further from the wall 56 than without the connector adapter 9.

However, in contrast to the connector 1 with connector adapter 9 in FIG. 6, the offset of the second plug face 11 towards the first plug face 3 ensures that the displaced center of gravity SPV continues to lie between the new first pivot point DP1′ and the new second pivot point DP2′ (although the second distance d2 is reduced compared to the first distance d1, it is still positive). This is because the connector adapter 9, with the second plug face 11 and the surface facing the wall 56, on which the two new pivot points DP1′, DP2′ are located, has been displaced in axial direction A in the direction of the center of gravity SP and also the displaced center of gravity SPV. As a result, the dead weight of the electrical connection unit 100 does not act as strongly and/or without movement on the connecting line 7 to loosen or release the plug connection.

Furthermore, the surface of the connector adapter 9 can be formed with a large surface by the recessed section 21, so that the electrical connection unit 100 rests against the wall 56 over a large surface.

Finally, the contacts 17, 18, 19, 55 of the second plug face 11 can be larger than those of the first plug face 3, and they can also be spread further apart. This also prevents the plug connection from loosening or coming loose, as the clamping force in the second socket 12 is greater than the clamping force of the first plug face 3 in the first socket 4. Finally, depending on the type of the second plug face 11, there can even be an additional contact in the second plug face 11 (e.g. NEMA 14-50 provides three current-carrying contacts, 2 phase contacts and a neutral conductor contact, of which only one of the two phase contacts and the neutral conductor contact are used with the connector 1 proposed here as an example). This additional contact can be a dummy contact 55 with no further electrical function in terms of power transmission, but it mechanically stabilizes the plug connection and also exerts a clamping force. The dummy contact 55 can, for example, be electrically connected to one of the other contacts 18, 19 (preferably the neutral conductor), e.g. via a high electrical dummy contact resistor 70, as shown dashed in FIG. 7. This can, for example, be at least 10 kOhm or at least 100 kOhm or at least 1 MOhm. Such a connection can be made directly in the plug-in connector adapter 9 as shown in FIG. 7. In principle, however, it is also conceivable that the dummy contact 55 protrudes through the connector adapter 9 (possibly with a different shape on the first side 35 of the connector adapter 9) and is only connected in the connector 1, for example to the protective conductor contact 14 or the neutral conductor.

If—as provided here as an example—a recessed section 21 is also provided on the connector 1, the connector adapter 9 does not protrude as far beyond the wall 24 of the connector housing 20 in the assembled state (here as an example in radial direction R). The electrical connection unit 100 therefore has a particularly small depth or width. This also reduces a possible tilting path or a tilt angle until the connector housing 20 abuts against the wall 56 when rotated about the new second pivot point DP2′ and blocks further rotation or tilting. This also means that the displaced center of gravity SPV is arranged particularly close to the wall 56. This also results in a lower torque, e.g. in the event of a pull on the connecting line 7.

In the exemplary embodiment shown in FIG. 7, the connector 1 without the connector adapter 9 lies close to and over a large surface on the wall 56, which prevents the plug connection from loosening or coming loose, despite the comparatively small dimensions of the first plug face 3, which also has a lower clamping force due to the small spread and dimensions of the contacts 14, 15, 16.

In the adapter case, i.e. with the connector adapter 9 attached, the connector 1 moves further away from the wall 56, but larger (longer and/or wider and/or deeper) contacts 17, 18, 19, 55 and more contacts with a greater spread over the surface (greater lateral distance between the contacts) are now available, which reduces the risk of the plug connection coming loose and/or loosening.

FIGS. 8a and 8b show schematic side views of an electrical connection unit 100 in two different mounting states of the connector adapter 9 on the connector 1. In FIG. 8a, the connector adapter 9 is not yet mounted on the connector 1, but mounting along the mounting direction M is prepared. In FIG. 8b, the connector adapter 9 is mounted on the connector 1.

As an example, the first plug face 3 is again designed as a NEMA 5-15 type and the second plug face as a NEMA 14-50 type. However, it is understood that the invention is not limited to this combination of plug faces.

It is very easy to see that the second plug face 11 is clearly offset from the first plug face 3 or the coupling 10 (here: downwards in the direction of the second end 6 or the second section). An overlap between coupling 10 or first plug face 3 and second plug face 11 is ultimately only present at the position of the protective conductor contact 14 and the second protective conductor contact 17. First plug face 3 and second plug face 11 are no longer aligned. The offset is approximately 15% to 25% of an extension length between the first end 2 or first section and the second end 6 or the second section of the connector housing 20 or the connector 1. The offset is preferably in the range between 10% and 50% and particularly preferably between 15% and 40% of this extension length between the first end 2 and the second end 6.

The recess 58 in the recessed section 21 can be clearly seen, which here has a depth (here in radial direction R) relative to the wall 24 which is, for example, approximately 20% to 40% of the length of the protective conductor contact 14. It goes without saying that the recess 58 can also have other dimensions. Advantageously, the recess 58 is between 10% and 90% of the length of the protective conductor contact 14, particularly advantageously between 15% and 70% and very particularly advantageously between 20% and 50%, e.g. 25% or 30% or 35% or 40% or 45%. In this way, the adapter housing 34 can be attached or fastened to the connector housing 20 in a partially recessed manner.

It is also easy to see that the other protective conductor contact 17 is aligned with the protective conductor contact 14. In addition, the second plug face 11 has a dummy contact 55 at the lower end, which has no electrical function for the electrical connection unit 100 in this example, but mechanically improves the plug connection with the second socket 12 (not shown here). As shown in FIG. 7, for example, it can be electrically connected to one of the other contacts 18, 19, e.g. the neutral conductor, via the dummy contact resistor 70 or connected to the protective conductor contact 14 in the mounted state. In particular, its position at the lower end (facing the connecting line 7) of the second plug face 11 prevents the plug connection from loosening or coming loose. The dummy contact 55 can be made of a non-electrically conductive material. It can, for example, be manufactured in one piece with the connector adapter 9 in an injection molding process. It can, for example, be made of plastic or contain plastic, especially for the most part. However, it can also be made of an electrically conductive material.

The connector adapter 9 has a fastening means 39 on the adapter housing 34 here as an example (and not substantially), with which the connector adapter 9 can be fastened to the connector 1 or the connector housing 20 or the holder 22. This allows the interface between the coupling 10 and the first plug face 3 to be mechanically relieved. This can also improve the tightness against the penetration of moisture, dirt and grime into the interface region. The fastening means 39 can, for example, be designed as a type of union nut or as a type of bayonet ring. It can be provided that a seal or sealing element, e.g. a sealing cord or an O-ring or the like, is provided between the connector adapter 9 and the connector 1 (not shown here). This can improve the tightness of the interface between the coupling 10 and the first plug face 3.

FIG. 8a clearly shows that the first plug face 3 is formed on or in or on a holder 22, which is spaced from the wall 24. A holder surface 23 of the holder 22 is designed in such a way that it is essentially flush with the wall 24. This provides a large, preferably flat, contact surface on the wall 56 (not shown here) for the connector 1 without the connector adapter 9 fitted. This also moves the first pivot point DP1 further away from the second pivot point DP2, which increases the stability of the plug connection.

FIGS. 9a and 9b show schematic views of an electrical connection unit 100 in two different mounting states of the connector adapter 9. This can be, for example, the electrical connection unit 100 shown in FIGS. 8a and 8b.

FIG. 9a clearly shows that the other contacts 18, 19 are spread wider and are also longer than the contacts 15, 16 of the first plug face. The other protective conductor contact 17 is also longer and has a larger diameter than the protective conductor contact 14 of the first plug face 3. This improves the plug connection in the second socket 12 (not shown here).

FIGS. 10a and 10b show two schematic perspective views of an electrical connection unit 100 in two different mounting states of the connector adapter 9. This can be, for example, the electrical connection unit 100 shown in FIGS. 8a and 8b.

In FIG. 10a, a detection unit 54 or a connecting element for a detection unit 54 can be seen on the holder surface 23. The detection unit 54 can, for example, couple with an encoding means transmission element 59 shown as an example in FIG. 12a. In this way, the type of the second plug face 11 of the connector adapter 9 can be transmitted or sent or transferred to the connector 1. It is understood that other transmission options, e.g. wireless transmission options, can also be provided.

FIG. 11 shows a schematic perspective view of a connector 1 with its first plug face 3 without connector adapter 9. The detection unit 54 is clearly visible, as are the recessed section 21 and the holder 22 with its holder surface 23. For example, this could be the connector 1 shown in FIGS. 8a through 10b.

FIG. 11 also shows a first surface F1 of the first plug face 3. The first surface F1 is located, for example, within the closed line, which is the shortest line that runs around all contacts 14, 15, 16 of the first plug face 3.

FIGS. 12a through 12c show different perspective views of a connector adapter 9 for coupling with a connector 1 of a charging cable 8. For example, this could be the connector adapter 9 shown in FIGS. 8a through 10b.

FIG. 12a shows a view of the first side 35 of the adapter housing 34. As already described above, an encoding means transmission element 59 can be recognized. By way of example only, the encoding means 26 can be a passive electrical component, e.g. an electrical resistor. The encoding means transmission element 59 can then consist, for example, in or of two contact elements which are connected to the detection unit 54 (e.g. two mating contact elements) of the connector 1. A first and/or second electronic circuit 27, 28 (see e.g. FIGS. 2a, 2b) can then determine the type of the second plug face 11 from the detected resistance.

FIG. 12a also shows the coupling surface FK. As an example, it lies within the closed line, which is the shortest line of the coupling elements, here as an example: clutch bushings that go around coupling 10.

FIG. 12b shows a view of the second side 36 of the adapter housing 34. A second surface F2 of the second plug face 11 is also shown. This second surface F2 lies within the line that runs as the shortest line around the contacts 17, 18, 19, 55 of the second plug face. The dummy contact 55 is located within the second surface F2.

FIG. 12c shows an oblique side view of the connector adapter 9.

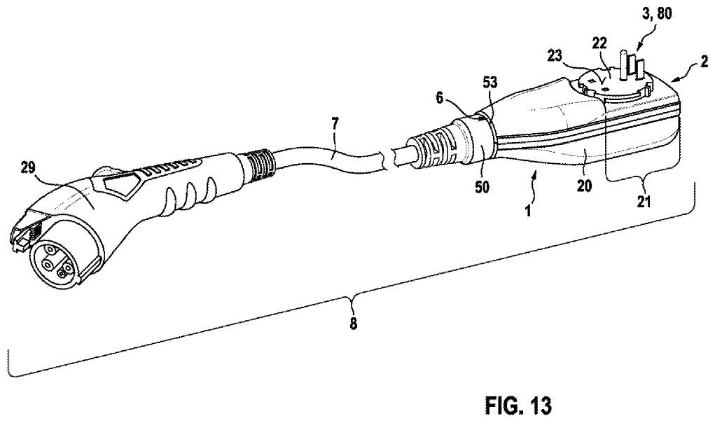

FIG. 13 shows a schematic perspective view of a charging cable 8 with a connector 1 on the infrastructure side for connection to a first socket 4 (in particular a household socket) without a connector adapter 9 and with a further connector 29 on the vehicle side. In this example, the charging cable 7 does not have an ICCB.

It is understood that the electrical connection unit 100, the connector adapter 9 and the connector 1 can also be provided for charging cables 8 with ICCB.

1. An electrical connection unit for a charging cable, the electrical connection unit comprising:
a connector (1), the connector (1) comprising
a first end (2) with a first plug face (3), set up for connection to a first socket (4) with a corresponding first socket shape (5);
a second end (6) for detachable or non-detachable coupling to a connecting line (7) of the charging cable (8);
a connector adapter (9), the connector adapter (9) comprising:
a coupling (10) for coupling to the first plug face (3);
a second plug face (11) for connecting to a second socket (12) with a second socket shape (13) which is different from the first socket shape (5);
wherein the connector adapter (9) is coupled to the first plug face (3) of the connector (1) by the coupling (10),
wherein the first plug face (3) has a protective conductor contact (14) and at least two, current-carrying contacts (15, 16),
wherein the second plug face (11) has a further protective conductor contact (17) or a neutral conductor contact and at least two further current-carrying contacts (18, 19), and
wherein the second plug face (11) is offset essentially perpendicularly to a mounting direction (M) of the connector adapter (9) relative to the coupling (10),
wherein the coupling (10) and the second plug face (11) overlap over at most 25% of their respective surface (FK, F2),
and/or
wherein the at least two further current-carrying contacts (18, 19) are arranged closer to the second end (6) of the connector (1) relative to the at least two current-carrying contacts (15, 16) and the protective conductor contact (14) is arranged between the at least two current-carrying contacts (15, 16) and the at least two further current-carrying contacts (18, 19) when viewed along a line (L) which extends from the first end (2) to the second end (6).

2. The electrical connection unit according to claim 1,
wherein the connector (1) has a connector housing (20) which extends along a longitudinal axis (A),
wherein the first plug face (3) projects from the connector housing (20) in a radial direction (R) perpendicular to the longitudinal axis (A),
wherein the connecting line (7) is coupled or can be coupled to the connector housing (20) along the longitudinal axis (A).

3. The electrical connection unit according to claim 2,
wherein the connector housing (20) has a recessed section (21) at the first end (2), wherein the recessed section (21) is configured to accommodate the connector adapter (9),
wherein the first plug face (3) is formed on a holder (22) in the recessed section (21),
wherein, a holder surface (23) of the holder (22) facing the first socket (4) is essentially aligned with a wall (24) of the connector housing (20) facing the first socket (4) and adjoining the recessed section (21).

4. The electrical connection unit according to claim 3,
wherein the holder (22) is spaced from the wall (24) adjoining the recessed section (21).

5. The electrical connection unit according to claim 1,
wherein the protective conductor contact (14) of the first plug face (3) is aligned with the further protective conductor contact (17) of the second plug face (11).

6. The electrical connection unit according to claim 1,
wherein the further protective conductor contact (17) or the neutral conductor is hollow at its end (25) facing the protective conductor contact (14), and the protective conductor contact (14) is plugged into the further protective conductor contact (17) or the neutral conductor.

7. The electrical connection unit according to claim 1,
wherein the first plug face (3) corresponds to a NEMA 5-15 plug face (80),
wherein the second plug face (11) corresponds to a plug face selected from the type group:
NEMA 6-15 (81), NEMA 6-20 (82), NEMA 10-30 (83), NEMA 14-30 (84), NEMA 14-50 (85), NEMA 6-50 (86).

8. The electrical connection unit according to claim 1,
wherein the connector adapter (9) has at least one encoding means (26) which encodes a type of the second plug face (11), wherein the encoding means (26) is selected from the group consisting of
a passive electronic component an encoding pin; an encoding rib; an encoding cutout; an encoding groove; a magnet; an electronic signature; a QR code.

9. The electrical connection unit according to claim 8,
wherein the connector (1) is configured to detect the type of the second plug face (11) by the encoding means (26) of the connector adapter (9),
wherein the connector (1) has a first electronic circuit (27) which is configured to control a power or voltage which can be transmitted via the connector (1) a function of the detected type of the second plug face (11),
and/or
which is configured to transmit the detected type of the second plug face (11) to a second electronic circuit (28) of the connector (1) or of the charging cable (8).

10. A charging cable for supplying a vehicle (200) with electrical energy or for extracting electrical energy from the vehicle (200), the charging cable (8) comprising:
an electrical connection unit (100) according to claim 1,
a further connector (29) which is configured to be electrically coupled to the vehicle (200), and
a connecting line (7) which is detachably or non-detachably coupled to the connector (1) and the further connector (29).

11. The charging cable according to claim 10,
wherein the further connector (29) has a control unit (30) for controlling the electrical current flow through the charging cable (8),
wherein the further connector (29) has a bypass switch (31) which is configured to optionally bypass the control unit (30) or to connect the control unit (30) to a control line (32) of the connecting line (7),
wherein the bypass switch (31) connects the control unit (30) to the control line (32) when a voltage from a voltage supply (33) of the connector (1) is present.

12. A connector adapter for coupling with a connector of a charging cable,
wherein the connector adapter (9) has a coupling (10) for coupling with a first plug face (3) of the connector (1), which is configured for coupling with a first socket shape (5) of a first socket (4),
wherein the connector adapter (9) can be plugged directly onto the first plug face (3),
wherein the connector adapter (9) has a second plug face (11) for connection to a second socket (12) with a second socket shape (13) which is different from the first socket shape (5),
wherein the second plug face (11) is offset essentially perpendicular to a mounting direction (M) of the connector adapter (7) relative to the coupling (10),
wherein, the coupling (10) and the second plug face (11) overlap over at most 25% of their respective surfaces (FK, F2).

13. The connector adapter according to claim 12,
wherein the coupling (10) and the second plug face (11) point in opposite directions.

14. The connector adapter according to claim 12,
wherein the connector adapter (9) has an adapter housing (34) with a first side (35) and a second side (36) facing away therefrom,
wherein the coupling (10) is formed on the first side (35) of the adapter housing (34),
wherein the second plug face (11) is formed on the second side (36) of the adapter housing (34).

15. The connector adapter according to claim 13,
wherein the connector adapter (9) has an adapter housing (34) with a first side (35) and a second side (36) facing away therefrom,
wherein the coupling (10) is formed on the first side (35) of the adapter housing (34),
wherein the second plug face (11) is formed on the second side (36) of the adapter housing (34).

16. The electrical connection unit according to claim 1, wherein the connector adapter (9) is plugged directly onto the first plug face (3) of the connector (1).

17. The electrical connection unit according to claim 1, wherein the second plug face (11) is offset essentially perpendicularly to the mounting direction (M) of the connector adapter (9) relative to the coupling (10) in a direction of the second end (6) of the connector (1).

18. The electrical connection unit according to claim 6, wherein the further protective conductor contact (17) or the neutral conductor is hollow along at least 25% of a length of the further protective conductor contact (17) or along at least 50% of the length of the further protective conductor contact (17) or along at least 75% of the length of the further protective conductor contact (17).

19. The electrical connection unit according to claim 8,
wherein the passive electronic component includes a resistor, a coil, or a capacitor, and
wherein the electronic signature is transmittable contact-based or contactless by RFID, NFC, Bluetooth®, WLAN, or optical.

20. The charging cable according to claim 11, wherein the further connector (29) has a control unit (30) for controlling the electrical current flow through the charging cable (8) when the connector (1) is connected to a household socket.
